(19) United States
(12) Patent Application Publication
(10) Pub. No.: US 2022/0227381 A1
(43) Pub. Date: Jul. 21, 2022

(54) Systems And Methods For Communicating Using A Vehicle

(71) Applicant: Ford Global Technologies, LLC, Dearborn, MI (US)

(72) Inventor: Nithya Somanath, Farmington Hills, MI (US)

(73) Assignee: Ford Global Technologies, LLC, Dearborn, MI (US)

(21) Appl. No.: 17/151,907

(22) Filed: Jan. 19, 2021

(51) Int. Cl. B60W 50/10; G10L 13/10; G10L 15/26; G10L 15/22; G06F 3/16; G06F 3/0481

(52) U.S. Cl. CPC B60W 50/10; G10L 13/10; G10L 15/26; G10L 15/22; B60W 2540/225; G06F 3/0481; B60W 2540/21; G10L 2015/223; G06F 3/16

(57) ABSTRACT

The disclosure provides systems and methods for communicating using a vehicle. The systems and methods provide a vehicle that includes a communication system. The communication system may include a human machine interface, an external vehicle speaker, a projector, an external vehicle display, and an external vehicle microphone.

### BACKGROUND

Communicating from a vehicle can be difficult for a hearing-impaired and for a speech impaired individual as many people do not know how to communicate using sign language. In a vehicle, communication may be required to place, confirm, or modify an order for a good or service. It is with respect to these and other considerations that the disclosure made herein is presented.

### DESCRIPTION OF THE FIGURES

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 illustrates a schematic illustration of a vehicle including a communication system in accordance with the present disclosure.

FIG. 2 is a schematic illustration of a method for communicating using a vehicle in accordance with the present disclosure.

FIG. 3 is a schematic illustration of vehicle systems in accordance with the present disclosure.

### DETAILED DESCRIPTION

### Overview

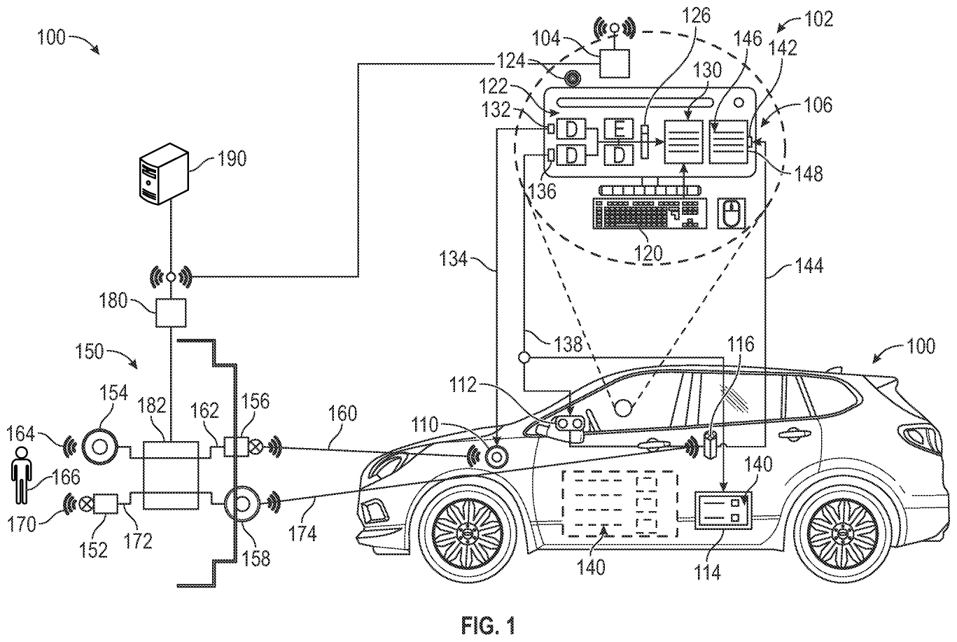

The disclosure provides systems and methods for communication using a vehicle. Referring to FIG. 1, the systems and methods provide a vehicle 100 that includes a communication system 102. The communication system 102 includes a Telematics Control Unit 104 (TCU) and a human machine interface 106 (HMI). The communication system further includes an external vehicle speaker 110, a projector 112, an external vehicle display 114, and an external vehicle microphone 116.

The HMI 106 is configured to receive text (e.g., from a keyboard 120) as HMI input 130 and selections from a menu (e.g., selection inputs 122 or buttons) as HMI input 130. For example, the HMI 106 may be part of a center stack of the vehicle 100 that includes a touchscreen, touchpad, one or more displays, and the like.

The HMI 106 may be configured to receive selections from the menu from a gaze detection system 124 (e.g., represented as a camera). For example, the gaze detection system 124 includes an infra-red light emitting diode (LED) and an infra-red camera that measures a positional relationship between a reference point (e.g., a corneal reflection of the infra-red light) and a moving point (e.g., a pupil reflection of the infra-red light). Based on the positional relationship, a gaze location can be determined. The gaze detection system 124 compares the gaze location to the areas of the selection inputs 122 on the HMI 106. If the gaze location is in an area of a selection input 122, the HMI 106 registers a selection of the selection input 122 as an HMI input 130.

The communication system includes a selection-to-text module 126 that is configured to convert one or more selections to text.

The communication system 102 includes a text-to-speech module 132 that is configured to convert the HMI input 130 to an audio signal 134 and output the audio signal 134 to the external vehicle speaker 110. The text and speech may be in any suitable language.

The communication system 102 includes a display module 136 that is configured to convert the HMI input 130 to an image signal 138 to display as an image 140 on the exterior of the vehicle 100 via the projector 112 and/or the external vehicle display 114.

In addition, the communication system 102 includes a speech-to-text module 142 that is configured to convert an audio signal 144 received at the external vehicle microphone 116 to text 146 and display the text 146 via a display 148 of the HMI 106.

The communication system 102 may be used to communicate with business systems 150. For example, the business systems 150 may include an internal business microphone 152 an internal business speaker 154, an external business microphone 156, and an external business speaker 158.

The external vehicle speaker 110 converts the audio signal 134 to a sound wave 160. The sound wave 160 is converted into an audio signal 162 by the external business microphone 156. The audio signal 162 is converted to a sound wave 164 by the internal business speaker 154. The sound wave 164 is received by a business employee 166. Alternatively, the audio signal 162 may be converted to text (e.g., by a speech-to-text module) and displayed for the business employee 166.

The business employee 166 may respond by speaking into the internal business microphone 152, which converts the speech 170 into an audio signal 172. The audio signal 172 is converted into a sound wave 174 by the external business speaker 158.

The sound wave 174 is received by the external vehicle microphone 116 and converted into the audio signal 144. The speech-to-text module 142 converts the audio signal 144 to text and displays the text 146 via the display 148 of the HMI 106.

Additionally or alternatively, the business employee 166 is able to view the image 140 and respond with speech communication as above or the business systems 150 may include a display to provide a visual response to the vehicle 100.

In some cases, at least part of the communication from the HMI 106 includes communication between the TCU 104 and a communication module of the business systems 150. For example, the TCU 104 is configured to communicate with a road-side unit 180 (RSU) using vehicle-to-everything (V2X) systems and methods. The RSU 180 is connected to a business computer 182 of the business systems 150. For example, the business systems 150 may be that of a fast-food restaurant or a bank or any drive-thru. The systems and methods described herein are applicable to any suitable business.

The vehicle 100 may generate and arrange payment for an order based on selections from a menu (e.g., selection inputs 122 or buttons) and communicate the order to the business systems 150 via the TCU 104 and the RSU 180. Communication that is outside of what is possible through the menu interface of the HMI 106 may be performed through other channels (e.g., audio, visual) of the communication system 102 as described above.

These and other advantages of the present disclosure are provided in greater detail herein.

### ILLUSTRATIVE EMBODIMENTS

The disclosure will be described more fully herein after with reference to the accompanying drawings, in which exemplary embodiments of the disclosure are shown, and not intended to be limiting. The disclosure provides systems and methods for communicating using a vehicle.

Referring to FIG. 1, the vehicle 100 includes the communication system 102. The communication system 102 includes the human machine interface 106 (HMI), the external vehicle speaker 110, and the external vehicle microphone 116.

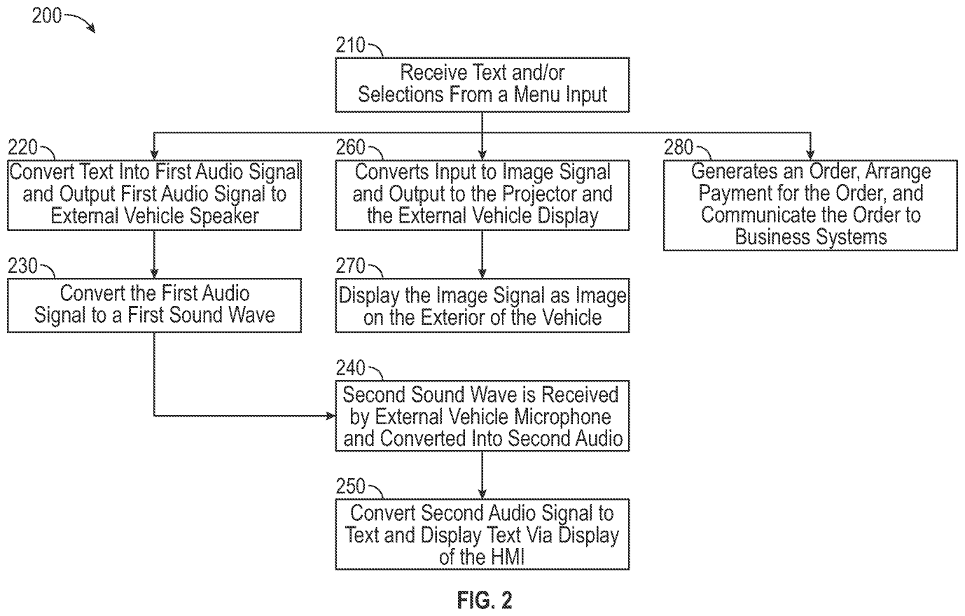

Referring to FIGS. 1 and 2, according to a first step 210 of an exemplary method 200, the HMI 106 receives text (e.g., from the keyboard 120) and/or selections from a menu (e.g., the selection inputs 122 or buttons, or via the gaze detection system 124) as HMI input 130. Selections (e.g., an order) as HMI input 130 may be converted into text by a selection-to-text module 126.

The HMI 106 may be configured to receive selections from the menu from a gaze detection system 124 (e.g., represented as a camera). For example, the gaze detection system 124 includes an infra-red light emitting diode (LED) and an infra-red camera that measures a positional relationship between a reference point (e.g., a corneal reflection of the infra-red light) and a moving point (e.g., a pupil reflection of the infra-red light). Based on the positional relationship, a gaze location can be determined. The gaze detection system 124 compares the gaze location to the areas of the selection inputs 122 on the HMI 106. If the gaze location is in an area of a selection input 122, the HMI 106 registers a selection of the selection input 122 as an HMI input 130.

According to a second step 220, the text-to-speech module 132 converts the text of the HMI input 130 into the audio signal 134 and outputs the audio signal 134 to the external vehicle speaker 110.

According to a third step 230, the external vehicle speaker 110 converts the audio signal 134 to the sound wave 160. The sound wave 160 is converted into the audio signal 162 by the external business microphone 156. The audio signal 162 is converted to the sound wave 164 by the internal business speaker 154. The sound wave 164 is received by the business employee 166. Alternatively, the audio signal 162 may be converted to text (e.g., by a speech-to-text module) and displayed as an image for the business employee 166.

The business employee 166 may respond by speaking into the internal business microphone 152, which converts the speech 170 into an audio signal 172. The audio signal 172 is converted into a sound wave 174 by the external business speaker 158.

According to a fourth step 240, the sound wave 174 is received by the external vehicle microphone 116 and converted into the audio signal 144. According to a fifth step 250, the speech-to-text module 142 converts the audio signal 144 to text and displays the text 146 via the display 148 of the HMI 106.

The communication system further includes the projector 112 and the external vehicle display 114. According to a sixth step 260, following step 210, the display module 136 converts the HMI input 130 to the image signal 138 (e.g., the image signal may include graphics and/or text) and outputs the image signal 138 to the projector 112 and the external vehicle display 114.

According to a seventh step 270, the projector 112 and the external vehicle display 114 display the image signal 138 as the image 140 (e.g., an image including graphics and/or text) on the exterior of the vehicle 100. Here, the business employee 166 is able to view the image 140 and respond with speech communication as is described with respect to steps 240, 250 or the business systems 150 may include a display to provide a visual response for the vehicle 100.

According to an eighth step 280, the vehicle 100 generates an order (e.g., via selection inputs 122 in step 210), arranges payment for the order, and communicates the order to the business systems 150 via the TCU 104 and the RSU 180. Communication that is outside of what is possible through the TCU 104 and the RSU 180 may be performed through other channels (e.g., audio, visual) of the communication system 102. For example, the vehicle 100 be used to communicate as described above with respect to steps 210, 220, 230 or steps 210, 260, 270. In addition, the business employee 166 is able to respond or initiate communication with speech communication as is described with respect to steps 240, 250 or the business systems 150 may include a display to provide a visual response for the vehicle 100.

As described above with respect to FIG. 1, the TCU 104 is configured to communicate with the road-side unit 180 (RSU), for example, using vehicle-to-everything (V2X) systems and methods. The RSU 180 is located at or incorporated into the infrastructure of the business and is connected to the business computer 182 of the business. For example, the business may be a fast-food restaurant, a bank, or any other suitable business.

The TCU 104 may store or receive a menu of options of goods and/or services and display the menu as selection inputs 122 on the HMI 106. A user chooses from the selection inputs 122 to create a list of selections (i.e., an order). The order is submitted through the HMI 106.

The TCU 104 communicates with the RSU 180 to confirm the order, arrange payment, and communicate the order to the business systems 150. The RSU 180 may be configured to communicate with a credit server 190 to process a payment for an order.

The TCU 104 may store the list of selections in memory. Orders or lists of selections from previous transactions may be used as suggested or promoted selection inputs 122 on the menu.

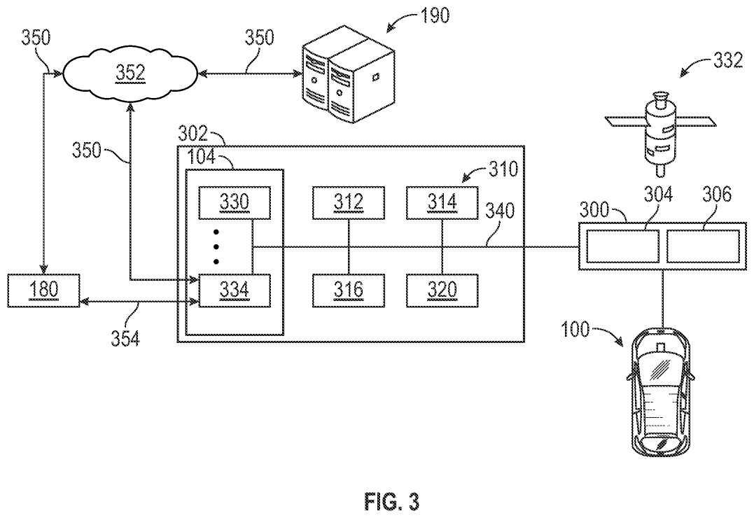

Referring to FIG. 3, systems are now described in further detail. The communication system 102 may be part of an automotive computer 300 or a vehicle control unit 302 (VCU). For example, the VCU 302 includes the TCU 104.

Each of the automotive computer 300, the RSU 180, and the business computer 182 includes computer components including a memory (e.g., memory 304) and a processor (e.g., a processor 306). A processor may be any suitable processing device or set of processing devices such as, but not limited to: a microprocessor, a microcontroller-based platform, a suitable integrated circuit, one or more field programmable gate arrays (FPGAs), and/or one or more application-specific integrated circuits (ASICs).

A memory may be volatile memory (e.g., RAM, which can include non-volatile RAM, magnetic RAM, ferroelectric RAM, and any other suitable forms); non-volatile memory (e.g., disk memory, FLASH memory, EPROMs, EEPROMs, memristor-based non-volatile solid-state memory, etc.), unalterable memory (e.g., EPROMs), read-only memory, and/or high-capacity storage devices (e.g., hard drives, solid state drives, etc.). In some examples, the memory includes multiple kinds of memory, particularly volatile memory and non-volatile memory.

Memory is computer readable media on which one or more sets of instructions, such as the software for performing the methods of the present disclosure, can be embedded. The instructions may embody one or more of the modules, methods, or logic as described herein. The instructions may reside completely, or at least partially, within any one or more of the memory, the computer readable medium, and/or within the processor during execution of the instructions.

The text-to-speech module, the speech-to-text module, and the image module may include a set of instructions for converting text to speech, speech to text, selection to text, selection to image, text to image, and the like. For example, the text-to-speech module may include instructions to perform methods such as concatenative synthesis, formant synthesis, articulatory synthesis, Hidden Markov Model (HMM) based synthesis, Sinewave synthesis, deep learning based synthesis, and the like. Speech-to-text systems may include instructions to perform methods such as HMM based speech recognition, Dynamic Time Warping (DTW) based speech recognition, neural networks, and the like.

The modules may be configured to convert text-to-speech and speech-to-text in any suitable language.

The terms “non-transitory computer-readable medium” and “computer-readable medium” should be understood to include a single medium or multiple media, such as a centralized or distributed database, and/or associated caches and servers that store one or more sets of instructions. The terms “non-transitory computer-readable medium” and “computer-readable medium” also include any tangible medium that is capable of storing, encoding or carrying a set of instructions for execution by a processor or that cause a system to perform any one or more of the methods or operations disclosed herein. As used herein, the term “computer readable medium” is expressly defined to include any type of computer readable storage device and/or storage disk and to exclude propagating signals.

Continuing with FIG. 3, the VCU 302 includes a plurality of electronic control units (ECUs) 310 disposed in communication with the automotive computer 300. The VCU 302 may coordinate the data between vehicle systems, connected servers (e.g., the credit server 190), and other vehicles operating as part of a vehicle fleet. The VCU 302 may control aspects of the vehicle 100, and implement one or more instruction sets received from a vehicle system controller (such as automotive computer 300).

The VCU 302 can include or communicate with any combination of the ECUs 310, such as, for example, a Body Control Module (BCM) 312, an Engine Control Module (ECM) 314, a Transmission Control Module (TCM) 316, the Telematics Control Unit 104 (TCU), a Restraint Control Module (RCM) 320, and the like. The TCU 104 may be disposed in communication with the ECUs 310 by way of a Controller Area Network (CAN) bus 340. In some aspects, the TCU 104 may retrieve data and send data as a CAN bus 340 node.

The CAN bus 340 may be configured as a multi-master serial bus standard for connecting two or more of the ECUs 310 as nodes using a message-based protocol that can be configured and/or programmed to allow the ECUs 310 to communicate with each other. The CAN bus 340 may be or include a high-speed CAN (which may have bit speeds up to 1 Mb/s on CAN, 5 Mb/s on CAN Flexible Data Rate (CAN FD)), and can include a low-speed or fault tolerant CAN (up to 125 Kbps), which may, in some configurations, use a linear bus configuration. In some aspects, the ECUs 310 may communicate with a host computer (e.g., the automotive computer 300, the RSU 180, and/or server(s), etc.), and may also communicate with one another without the necessity of a host computer.

The CAN bus 340 may connect the ECUs 310 with the automotive computer 300 such that the automotive computer 300 may retrieve information from, send information to, and otherwise interact with the ECUs 310 to perform steps described according to embodiments of the present disclosure. The CAN bus 340 may connect CAN bus nodes (e.g., the ECUs 310) to each other through a two-wire bus, which may be a twisted pair having a nominal characteristic impedance. The CAN bus 340 may also be accomplished using other communication protocol solutions, such as Media Oriented Systems Transport (MOST) or Ethernet. In other aspects, the CAN bus 340 may be a wireless intra-vehicle CAN bus.

The VCU 302 may control various loads directly via the CAN bus 340 communication or implement such control in conjunction with the BCM 312. The ECUs 310 described with respect to the VCU 302 are provided for exemplary purposes only, and are not intended to be limiting or exclusive. Control and/or communication with other control modules is possible, and such control is contemplated.

The ECUs 310 may control aspects of vehicle operation and communication using inputs from human drivers, inputs from a vehicle system controller, and/or via wireless signal inputs received via wireless channel(s) from other connected devices. The ECUs 310, when configured as nodes in the CAN bus 340, may each include a central processing unit (CPU), a CAN controller, and/or a transceiver.

The TCU 104 can be configured to provide vehicle connectivity to wireless computing systems onboard and offboard the vehicle 100 and is configurable for wireless communication between the vehicle 100 and other systems, computers, servers, RSUs 180, and modules.

For example, the TCU 104 includes a Navigation (NAV) system 330 for receiving and processing a GPS signal from a GPS 332, a Bluetooth® Low-Energy Module (BLEM) 334, a Wi-Fi transceiver, an Ultra-Wide Band (UWB) transceiver, and/or other wireless transceivers described in further detail below for using near field communication (NFC) protocols, Bluetooth® protocols, Wi-Fi, Ultra-Wide Band (UWB), and other possible data connection and sharing techniques.

The TCU 104 may include wireless transmission and communication hardware that may be disposed in communication with one or more transceivers associated with telecommunications towers (e.g., cellular tower) and other wireless telecommunications infrastructure. For example, the BLEM 334 may be configured and/or programmed to receive messages from, and transmit messages to, one or more cellular towers associated with a telecommunication provider, and/or and a Telematics Service Delivery Network (SDN) associated with the vehicle 100 for coordinating vehicle fleet.

The BLEM 334 may establish wireless communication using Bluetooth® and Bluetooth Low-Energy® communication protocols by broadcasting and/or listening for broadcasts of small advertising packets, and establishing connections with responsive devices that are configured according to embodiments described herein. For example, the BLEM 334 may include Generic Attribute Profile (GATT) device connectivity for client devices that respond to or initiate GATT commands and requests.

The RSU 180 and the TCU 104 may include radios configured to transmit (e.g., broadcast) and/or receive vehicle-to-everything (V2X) signals broadcast from another radio. Dedicated Short Range Communication (DSRC) is an implementation of a vehicle-to-everything (V2X) or a car-to-everything (CV2X) protocol. Any other suitable implementation of V2X/C2X may also be used. Other names are sometimes used, usually related to a Connected Vehicle program or the like.

The RSU 180 and the TCU 104 may include radio frequency (RF) hardware configured to transmit and/or receive signals, for example, using a 2.4/5.8 GHz frequency band.

Communication technologies described above, such as CV2X, may be combined with other technologies, such as Visual Light Communications (VLC), Cellular Communications, and short-range radar, facilitating the communication of position, speed, heading, relative position to other objects, and the exchange of information with other vehicles, mobile devices, RSUs, or external computer systems.

External servers (e.g., credit servers 190) may be communicatively coupled with the vehicle 100 and the RSU 180 via one or more network(s) 352, which may communicate via one or more wireless channel(s) 350. The wireless channel(s) 350 are depicted in FIG. 3 as communicating via the one or more network(s) 352.

The RSU 180 may be connected via direct communication (e.g., channel 354) with the vehicle 100 using near field communication (NFC) protocols, Bluetooth® protocols, Wi-Fi, Ultra-Wide Band (UWB), and other possible data connection and sharing techniques.

The network(s) 352 illustrate example communication infrastructure in which the connected devices discussed in various embodiments of this disclosure may communicate. The network(s) 352 may be and/or include the Internet, a private network, public network or other configuration that operates using any one or more known communication protocols such as, for example, transmission control protocol/Internet protocol (TCP/IP), Bluetooth®, Wi-Fi based on the Institute of Electrical and Electronics Engineers (IEEE) standard 802.11, WiMAX (IEEE 802.16m), Ultra-Wide Band (UWB), and cellular technologies such as Time Division Multiple Access (TDMA), Code Division Multiple Access (CDMA), High Speed Packet Access (HSPDA), Long-Term Evolution (LTE), Global System for Mobile Communications (GSM), and Fifth Generation (5G), Universal Mobile Telecommunications System (UMTS), Long Term Evolution (LTE), and the like.

The BCM 312 generally includes an integration of sensors, vehicle performance indicators, and variable reactors associated with vehicle systems, and may include processor-based power distribution circuitry that can control functions associated with the vehicle body such as lights, windows, security, door locks and access control, and various comfort controls. The BCM 312 may also operate as a gateway for bus and network interfaces to interact with remote ECUs.

The BCM 312 may coordinate any one or more functions from a wide range of vehicle functionality, including energy management systems, alarms, vehicle immobilizers, driver and rider access authorization systems, Phone-as-a-Key (PaaK) systems, driver assistance systems, Autonomous Vehicle (AV) control systems, power windows, doors, actuators, and other functionality, etc. The BCM 312 may be configured for vehicle energy management, exterior lighting control, wiper functionality, power window and door functionality, heating ventilation and air conditioning systems, and driver integration systems. In other aspects, the BCM 312 may control auxiliary equipment functionality, and/or is responsible for integration of such functionality. In one aspect, a vehicle having a vehicle control system may integrate the system using, at least in part, the BCM 312.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a feature, structure, or characteristic is described in connection with an embodiment, one skilled in the art will recognize such feature, structure, or characteristic in connection with other embodiments whether or not explicitly described.

It should also be understood that the word “example” as used herein is intended to be non-exclusionary and non-limiting in nature. More particularly, the word “exemplary” as used herein indicates one among several examples, and it should be understood that no undue emphasis or preference is being directed to the particular example being described.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Computing devices may include computer-executable instructions, where the instructions may be executable by one or more computing devices such as those listed above and stored on a computer-readable medium.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating various embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation. All terms used in the claims are intended to be given their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

1. A vehicle, comprising:
a communication system, comprising:
a human machine interface configured to receive an input;
a text-to-speech module configured to generate a first audio signal based on the input; and
an external speaker configured to receive the first audio signal and convert the first audio signal to a first soundwave.

2. The vehicle of claim 1, wherein the input is at least one of a text input and a selection input.

3. The vehicle of claim 2, comprising a selection-to-text module configured to generate a text input from a selection input.

4. The vehicle of claim 1, comprising an external microphone configured to receive a second soundwave and generate a second audio signal.

5. The vehicle of claim 4, comprising a speech-to-text module configured to generate an output based on the second audio signal, wherein the human machine interface is configured to display the output.

6. The vehicle of claim 5, wherein the output is at least one of text and an image.

7. The vehicle of claim 1, wherein the human machine interface includes a touchscreen.

8. The vehicle of claim 1, wherein the human machine interface includes a gaze detection system.

9. The vehicle of claim 1, wherein the communication system is configured to generate, via the human machine interface, an order.

10. The vehicle of claim 9, wherein the communication system is configured to send the order to a road-side unit.

11. The vehicle of claim 10, wherein the road-side unit is associated with a business location.

12. The vehicle of claim 1, the communication system comprising an image module configured to generate an image based on the input to the human machine interface.

13. The vehicle of claim 12, the communication system comprising at least one of a projector and an external display that is configured to display the image on the outside of the vehicle.

14. A vehicle, comprising:
a communication system, comprising:
a human machine interface configured to receive an input;
a image module configured to generate an image based on the input; and
at least one of a projector and an external display that is configured to display the image on the outside of the vehicle.

15. The vehicle of claim 14, wherein the input is at least one of a text input and a selection input.

16. The vehicle of claim 14, comprising an external microphone configured to receive a second soundwave and generate an audio signal.

17. The vehicle of claim 16, comprising a speech-to-text module configured to generate an output based on the audio signal, wherein the human machine interface is configured to display the output.

18. The vehicle of claim 17, wherein the output includes at least one of text and an image.

19. The vehicle of claim 14, wherein the human machine interface includes a touchscreen.

20. The vehicle of claim 14, wherein the human machine interface includes a gaze detection system.
